(19) United States
(12) Patent Application Publication
(10) Pub. No.: US 2014/0299061 A1
(43) Pub. Date: Oct. 9, 2014

(54) GATE ARRANGEMENT TO A FENCED AREA FOR AT LEAST ONE ANIMAL

(71) Applicant: DELAVAL HOLDING AB, Tumba (SE)

(72) Inventor: Magnus Larsson, Bromma (SE)

(73) Assignee: DELAVAL HOLDING AB, Tumba (SE)

(21) Appl. No.: 14/364,117

(22) PCT Filed: Dec. 21, 2012
(86) PCT No.: PCT/SE2012/051479

§ 371 Date: Jun. 10, 2014

Related U.S. Application Data
(60) Provisional application No. 61/579,068, filed on Dec. 22, 2011.

(30) Foreign Application Priority Data
Dec. 22, 2011 (SE) 1151267-0

(51) Int. Cl. E05C 19/16; A01K 1/12; A01J 5/00; A01K 3/00

(52) U.S. Cl. CPC E05C 19/166; A01K 3/00; A01K 1/12; A01J 5/00
USPC 119/14.03; 119/416

(57) ABSTRACT

A gate arrangement to a fenced area for at least one animal includes a gate movably arranged between a closed position and open position in an opening to the fenced area, and a lock mechanism that locks the gate when the gate is in the closed position. The lock mechanism locks the gate in the closed position with an adjustable specific locking force such that the gate is opened by applying a larger force than the specific force on the gate, and the gate arrangement includes a force adjusting unit that sets the lock mechanism in an unlocked state and in at least two different locked states, in which the gate is locked by two different specific locking forces.

### BACKGROUND OF THE INVENTION AND PRIOR ART

The present invention relates to a gate arrangement to a fenced area for at least one animal, wherein the gate arrangement comprises a gate movably arranged between a closed position and open position in an opening to the fenced area, and a lock mechanism capable of locking the gate when it is in the closed position.

A milking stall for automatic milking of cows comprises a milking robot attaching teat cups to the cows. The milking stall constitutes usually a fenced area defined by a fence arrangement or the like. The fence arrangement comprises an entrance gate, which is opened when the milking stall is vacant and a cow is to be milked. The milking stall comprises an exit gate, which is opened when it is time for the cow to leave the milking stall after a milking process. The entrance gate and the exit gate are moved between a closed position and an open position by means of a respective pneumatic cylinder.

A milking stall constitutes a relatively narrow area for the cows. It happens that cows escape from the milking stall. It is relatively easy for strong cows to push the exit gate to an open position against the action of the pneumatic cylinder and leave the milking stall before a milking process has finished. In order to prevent cows from leaving the milking stall before the exit gate is open, some farmers have provided the exit gate with a lock mechanism. The lock mechanism is activated when the pneumatic cylinder has moved the exit gate to the closed position. In this case, a panic-stricken cow does not have the possibility to leave the milking stall when the exit gate is closed. Even a panic-stricken cow will have to stay in the milking stall, with risks for injuries of the cow and damages of equipment in the milking stall.

### SUMMARY OF THE INVENTION

The object of the present invention is to provide a gate arrangement to a fenced area for animals, which is capable of preventing an unwanted opening of the gate when it is in the closed position, but allowing an opening of the gate if an animal in the fenced area becomes panic-stricken and applies an exceptionally large force on the gate.

This object is achieved according to the invention by the feature that the lock mechanism is configured to lock the gate in the closed position by a specific locking force such that it is possible to open the gate by applying a larger force than the specific force on the gate, and that the gate arrangement comprises force adjusting means configured to set the lock mechanism in an unlocked state and in at least two different locked states in which the gate is locked by two different specific locking forces. Thus, it is always possible to open the gate by applying a large enough force on the gate. Different breeds of cows are of different sizes and capable of applying differently sized forces on a gate. By means of the present invention, it is possible to adjust the specific locking force to a suitable value to for example a certain breed of cows, at which it is difficult for the cows in the herd to open the gate, but not impossible if they for example become panic-stricken and apply an exceptionally large force on the gate. The specific force may be elected by a suitable number of fixed specific values. Alternatively, it is possible to adjust the specific force in a stepless manner to a suitable value. By means of such a lock mechanism, it is possible to prevent unwanted opening of the gate when it is in a closed position, at the same time as it is possible for the animals to open the gate if they get really panic-stricken.

According to an embodiment of the invention, the lock mechanism has a design such that it allows opening of the gate without deformation of any included components when a larger force than said specific force is applied to the gate. In this case, it is possible to continue using the lock mechanism regardless of how many times it has been opened by panic-stricken animals.

According to a preferred embodiment of the invention, the lock mechanism is an electromagnetic lock mechanism. The force exerted by an electromagnet can be precisely controlled by changing the current applied to the electromagnet. Thus, it is very easy to adjust the specific force of an electromagnetic lock mechanism. Alternatively, the lock mechanism is a mechanical lock mechanism. Such a mechanism may include a lock member held in a locking position by means of an adjustable spring mechanism.

According to a preferred embodiment of the invention, the lock mechanism comprises a first part comprising an electromagnet, and a second part comprising a contact member of a magnetisable material having a contact surface configured to come in contact with a contact surface of the electromagnet when the gate is in the closed position. Preferably, the contact surfaces of the electromagnet and the contact member are flat or have a curved complementary shape allowing a good contact over the entire contact surfaces when the gate is in the closed position. A good contact between the contact surfaces of the electromagnet and the contact member in an electromagnetic lock mechanism is a condition for establishing a specific locking force with a high accuracy. One of said parts of the lock mechanism may be mounted on a stationary element in the vicinity of the opening to the fenced area, and the other part of the lock mechanism is mounted on the gate. Thus, the first part including the electromagnet may be mounted on a suitable place on the gate or on a stationary element which may define the opening to the fenced area. The second part including the contact member may be mounted in a position on the gate or on the stationary element, such that the contact surface of the contact member comes in contact with the contact surface of the electromagnet when the gate reaches the closed position.

According to a preferred embodiment of the invention, the first part of the lock mechanism comprises a casing arranged around the electromagnet. The electromagnet and a possible coil wrapped around the electromagnet obtain a protected position inside such a casing. The casing may have an opening defined by a contact surface arranged in the same plane as the contact surface of the electromagnet. The casing may be manufactured of a magnetisable material. In this case, the contact surfaces of the casing are also used to lock the gate with the specific locking force.

According to a preferred embodiment of the invention, the lock mechanism comprises position adjusting means configured to adjust the relative position between the contact member and the electromagnet such that they obtain an optimized contact when the gate is in the closed position. Thus, a good contact between the contact surfaces of the electromagnet and the contact member is very important. By the use of position adjusting means, the contact surfaces will automatically be moved to an optimized contact position in relation to each other. Said position adjusting means may comprise a resilient suspension of the contact member and/or the electromagnet. Thus, one or both of said components may have a resilient suspension. In this case, the electromagnetic lock mechanism may be designed such that the contact surfaces of the electromagnet and the contact member come in initial contact just before the exit gate reaches the closed position. During the following movement of the exit gate towards the closed position, the resilient suspension allows an adjustment of the position of the contact surfaces in relation to each other to an optimized contact position.

According to a preferred embodiment of the invention, said position adjusting means may comprise angle adjusting means configured to adjust the relative angle between the contact surface of the contact member and the contact surface of the electromagnet. An angle adjustment is many times necessary in order to achieve an optimized contact between the contact surfaces of the electromagnet and the contact member. The angle adjusting means may comprise a universal joint. In this case, it is possible to adjust the angle between the electromagnet and the contact member in a universal manner. Such a universal joint may be a ball joint. Alternatively, such angle adjusting means may comprise a joint allowing a rotary motion of the electromagnet or the contact member around a pivot axis. Such an angle adjustment is in certain cases sufficient in order to achieve an optimized contact between the contact surfaces.

According to a preferred embodiment of the invention, the gate arrangement comprises a power member and a control unit configured to control the power member such that it moves the gate between the open position and the closed position. The power member may be a pneumatic cylinder or a hydraulic cylinder. The control unit may be a computer or the like comprising software for the above mentioned control of the gate and supply of current to the electromagnet.

According to a preferred embodiment of the invention, the control unit is configured to receive information about the identity of an animal in the fenced area from an identity sensor and to control the force adjusting means such that the lock mechanism locks the gate with a specific locking force in view of stored information about the animal in the fenced area. The animals in a herd are different—some animals are able to apply larger forces on the gate than other animals. It is here possible to lock the gate with a specific force of different values for the individual animals. This specific force may for example depend on the weight of the animal, so that a larger force is used for a heavier animal. It is also possible to adjust the locking force for the individual animals in view of, for example, stored information from previous milking processes of individual animals. A larger force may thereby be used for example for animals which have previously tried to escape from the milking stall.

According to a preferred embodiment of the invention, the lock mechanism is arranged at a level that is closer to the level of the highest located part of the gate than the level of the lowest located part of the gate. It is a dirty environment in a milking stall, especially in the vicinity of the floor, and electromagnetic lock mechanisms are sensible to dirt. In order to prevent the lock mechanism from being exposed to too much dirt, it is suitable to place the lock mechanism at a relatively high level above the floor surface. The lock mechanism may, for example, be placed on the uppermost part of the gate.

According to a preferred embodiment of the invention, the fenced area is a milking stall. A milking stall is a relatively narrow area and there is a risk that an animal gets really panic-stricken in connection with a milking process. A panic-stricken animal is usually able to apply a larger force on the gate than the specific locking force, and thereby escape from the milking stall. By the invention, injuries on the animal and damages on equipment in the milking stall may be avoided. The milking stall may be an automatic milking stall provided with a milking robot. Such milking stalls are unmanned and there is no guarantee that any person is nearby, notes if a cow gets panic-stricken in the milking stall and takes steps to help the cow. The gate may be an exit gate of the milking stall. The gate may also be an entrance gate of the milking stall. It is of course also possible to use the lock mechanism to lock gates in other kinds of fenced areas for animals than milking stalls.

According to an embodiment of the invention, the lock mechanism also comprises a hinge mechanism for the gate. In this case, the lock mechanism also has the function to be a disconnectable hinge mechanism. The gate is here able to swing around a pivot axis of the hinge mechanism when the lock mechanism is in the unlocked state. The gate arrangement may comprise at least one lock and hinge mechanism at one end portion of the gate and at least one lock and hinge mechanism at an opposite end portion of the gate.

The gate is here supported by at least one disconnectable hinge mechanism at one end of the gate and at least one disconnectable hinge mechanism at the opposite end of the gate. It is here possible to disconnect the hinge mechanisms on the respective sides of the gate and swing the gate from a closed position to two different open positions. Such a gate may be used in a milking stall as both entrance gate and exit gate.

### BRIEF DESCRIPTION OF THE DRAWINGS

In the following, preferred embodiments of the invention are described by examples and with references to the attached drawings, in which

FIG. 1 shows a milking stall with a gate arrangement according to a first embodiment of the invention,

FIG. 2 shows an exploded view of an electromagnetic lock which may be used in a gate arrangement according to the invention,

FIG. 3 shows the electromagnetic lock in FIG. 2 in a connected state,

FIG. 4 shows a view from the above of a milking stall with a gate arrangement according to a second embodiment of the invention,

FIG. 5 shows a front view of the milking stall in FIG. 4 and

FIG. 6 shows a view along the plane A-A of the electromagnetic lock mechanism in FIG. 5.

### BRIEF DESCRIPTION OF PREFERRED EMBODIMENTS OF THE INVENTION

FIG. 1 shows a milking stall 2 for automatic milking of cows 1. The milking stall 2 is defined by a fence arrangement comprising a number of stationary sections 2a-2d and two pivotally arranged gates in the form of an entrance gate 2d₁ and an exit gate 2d₃. The stationary sections comprise a front short side section 2a, a rear short side section 2b, a right long side section 2c and a left long side section 2d. The left long side section 2d comprises an upper stationary element and a stationary middle part. A rear part of the left long side section 2d comprises an opening in which the entrance gate 2d₁ is mounted. A front part of the left long side section 2d comprises an opening in which the exit gate 2d₂ is mounted. Each of the entrance gate 2d₁ and the exit gate 2d₂ is pivotally arranged between a closed position and an open position in the respective openings. The fence sections 2a-2d are here named in view of their positions in relation to a cow 1 standing in a milking position in the milking stall 2.

The milking stall 2 comprises a schematically disclosed milking robot 3 configured to attach teat cups to the teats of the cow 1 in the milking stall 2. A feeding trough 4 is arranged in a front portion of the milking stall. The feeding trough 4 attracts the cows 1 and facilitates the positioning of the cows 1 in the milking stall. The milking stall 2 comprises further a control unit 5 configured to control the milking robot 3, the entrance gate 2d₁ and the exit gate 2d₂. The control 5 unit receives information from an identifying sensor 6 about the identity of the cow 1 in the milking stall.

A first pneumatic cylinder 7a is configured to move the entrance gate 2d₁ between an open position and a closed position. A second pneumatic cylinder 7b is configured to move the exit gate 2d₂ between an open position and a closed position. The control unit 5 controls the activation of the first pneumatic cylinder 7a and the second pneumatic cylinder 7b. An electromagnetic lock mechanism 8 is arranged at an upper part of the exit gate 2d₂. The lock mechanism 8 is, in this case, configured to lock the gate 2d₂ with a specific force against the upper stationary element of the left long side section 2d of the milking stall. The electromagnetic lock mechanism 8 is configured to lock the exit gate 2d₂ by a specific force such that it is possible to open the exit gate 2d₂ by applying a larger force than the specific force on the exit gate 2d₂.

The electromagnetic lock mechanism 8 is controlled by the control unit 5. The control unit 5 comprises software 5a controlling the supply of current to the electromagnetic lock mechanism 8. The software 5a is able to control the supply of current such that the electromagnetic lock mechanism 8 can be set in an unlocked state and in at least two different locked states. In the unlocked state, no current is fed to the electromagnetic lock mechanism 8. In the locked states, different amounts of current are fed to the electromagnetic lock mechanism 8 in the respective locked states. The control unit 5 may use the same energy source for the activation of the pneumatic cylinders 7a, 7b and for the supply of current to the electromagnetic lock mechanism 8. A simple electromagnet consists of a coil that is wrapped around an iron core. The force exerted by the electromagnet is related to the amount of current fed to the coil. The different amounts of current fed to the electromagnet result in different locking forces of the electromagnetic lock mechanism 8. Thus, in this case, it is possible to lock the exit gate 2d₂ in the closed position by at least two different specific locking forces.

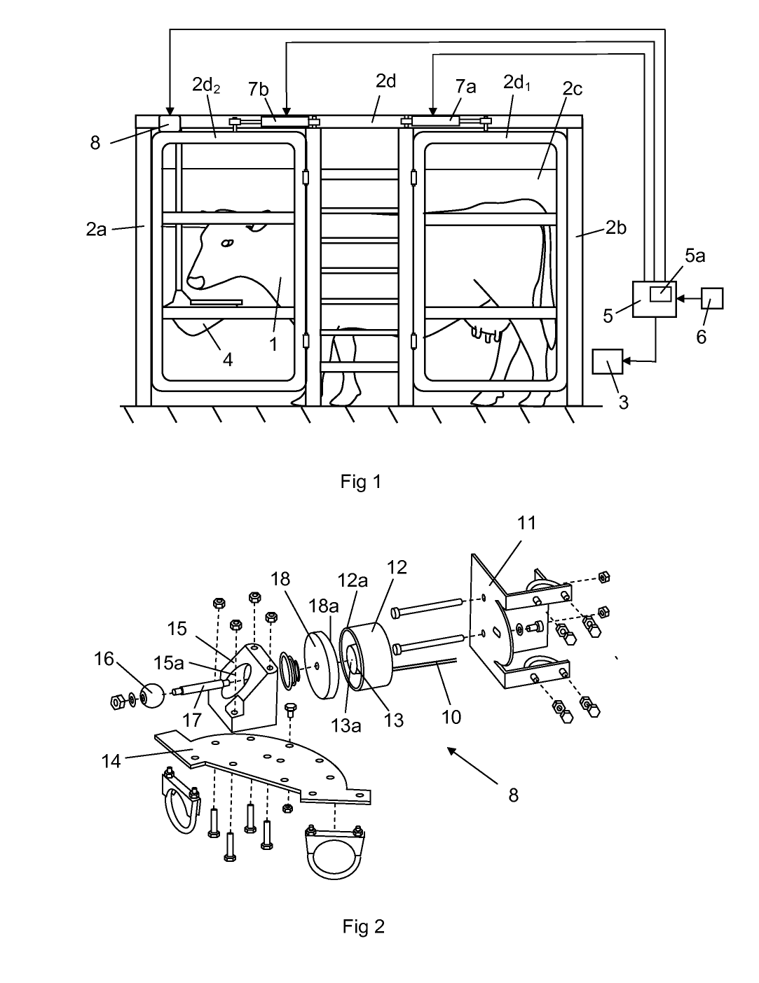

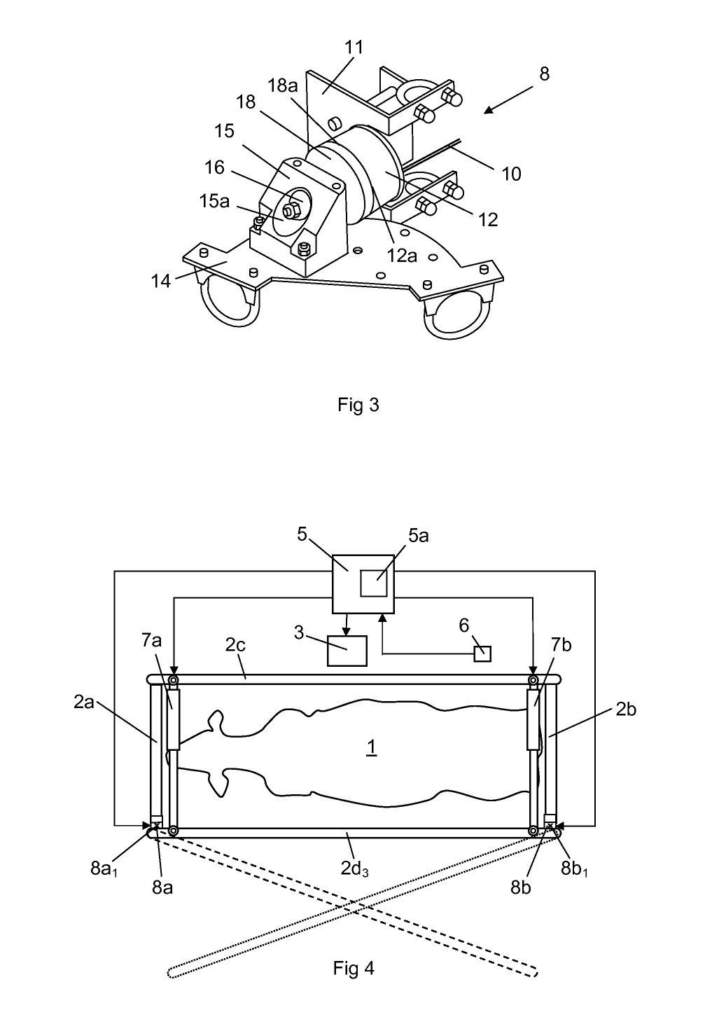

FIGS. 2 and 3 show an example of an electromagnetic lock mechanism 8 to be used in the milking stall in FIG. 1. The electromagnetic lock mechanism 8 comprises a first L-shaped plate bracket 11 to be mounted on a stationary part of the fence arrangement 2 by means of bolts, U-bolts and nuts. A cylinder shaped casing 12 is attached on the first plate bracket 11. The cylinder shaped casing 12 comprises, at a free end, an opening defined by a contact surface 12a. An electromagnet 13 is arranged inside the casing 12. The electromagnet 13 is provided with a contact surface 13a. The contact surface 13a of the electromagnet and the contact surface 12a of the casing are arranged in the same plane. The electric wiring 10 feeds current to a coil wrapped around the electromagnet 13 in the casing 12. The coil is not visible in FIGS. 2 and 3. The coil may be moulded into the casing 12. The casing 12 is made of a magnetisable material. Thereby, the casing 12 also works as a magnet when current is fed to the coil.

The electromagnetic lock mechanism 8 comprises a second plate bracket 14 to be mounted to an upper part of the exit gate 2d₂ by means of bolts, U-bolts and nuts. An attaching member 15 is attached on the second plate bracket 14. The attaching member 15 comprises a through hole 15a configured to receive a ball 16. The ball 16 is, via a pin 17, connected to a plate-shaped contact member 18. The ball 16, the pin 17 and the contact member 18 constitute a connected unit in a mounted state. A spring member 19 is arranged between a wall surface of the attaching member 15 and a surface of the contact member 18. The spring member 19 provides a resilient suspension of the contact member 18, the pin 17 and the ball 16 in relation to the attaching member 15. The spring member 19 holds, in an unloaded state, the contact member 18 at a maximum distance from the attaching member 15. The through hole 15 has an opening for the pin 17. This opening has a smaller cross section area than the ball 16, such that the ball 16 is not able to leave the trough hole 15a. At least a front surface 18a of the contact member 18 is made of a magnetisable material.

The electromagnetic lock mechanism 8 is designed such that the contact member 18 comes in contact with the contact surfaces 13a of the electromagnet 13 and the contact surface 12a of the casing 12 just before the exit gate 2d₂ reaches the closed position. During the last movement of the exit gate 2d₂ towards the closed position, the spring member 19 is compressed such that the contact surface 18 of the contact member 18 will be pressed against the contact surface 13a of the electromagnet and the contact surface 12a of the casing 12 with a spring force. The spring force ensures a good contact between the contact surfaces 12a, 13a, 18a. Furthermore, the spring member 19 allows a continued movement of the exit gate 2d₂ to the closed position after the initial contact between the contact surfaces 12a, 13a, 18a. Thereby, the contact member 18, the electromagnet 13 and the casing 12 do not need to be mounted in very accurate positions in relation to each other for ensuring a good contact between the contact surfaces 12a, 13a, 18a when the exit gate 2d₃ is in the closed position.

Furthermore, the contact member 18 is also suspended by means of the pin 17 and the ball 16 which is arranged in the through hole 15a of the attaching member 15. Since the ball 16 is able to turn inside the through hole 15a, it is also possible to adjust the angle of the contact surface 18a of the contact member 18 in relation to the contact surface 13a of the electromagnet 13 and the contact surface 12a of the casing 12. When the contact member 18 obtains contact with the electromagnet 13 and the casing 12, the resilient suspension of the contact member 18 is compressed and it exerts a spring force turning the contact member 18 and the ball 16 to an angle in which the contact surface 18a obtains a good contact with the contact surface 13a of the electromagnet 13 and the contact surface 12a of the casing 12. Thus, the suspension of the plate shaped member 18 in the attaching member 15 ensures an optimized contact between the contact surface 12a, 13a, 18a when the exit gate 2d₃ reaches the closed position. The electromagnetic lock mechanism 8 requires a good contact between said contact surfaces 12a, 13a, 18a in order to be capable of locking the exit gate 2d₂ with the specific locking force in the respective lock states.

When a cow 1 is to be milked in the milking stall 2, the control unit 5 activates the first pneumatic cylinder 7a such that it moves the entrance gate 2d₁ to an open position. When the cow 1 has entered the milking stall, the control unit 5 activates the first pneumatic cylinder 7a such that it moves the entrance gate 2d₁ to a closed position. The identification sensor 6 detects the identity of the cow 1 in the milking stall 2. The control unit 5 elects a suitable specific locking force of the exit gate 2d₂ for this individual cow 1, for example based on its size or weight. The control unit 5 feeds an amount of current to the electromagnet 13, such that the electromagnetic lock 8 locks the exit gate 2d₂ with the specific locking force. The specific locking force is of a value such that it is difficult but not impossible for this individual cow 1 to open the exit gate 2d₂. The cow 1 has to be able to open the exit gate 2d₂ in a panic-stricken state.

The control unit 5 activates the milking robot 3 such that it attaches teat cups to the teat of the cow 1 and the milking process starts. When the milking process has finished and it is time for the cow 1 to leave the milking stall, no current is fed to the electromagnetic lock mechanism 8. The electromagnetic lock mechanism 8 has now been set in the non-locked state, and the locking force between the casing 12, the electromagnet 13 and the contact member 18 ceases. The control unit 5 then activates the second pneumatic cylinder 7b such that it moves the exit gate 2d₂ to an open position, and the cow 1 leaves the milking stall. The control unit 5 activates the second pneumatic cylinder 7b such that it moves the exit gate 2d₂ towards the closed position. When the exit gate 2d₃ reaches the closed position, the contact surface 18a of the contact member 18 is, by means of its suspension in the attaching member 15, adjusted to an optimized contact position in relation to the contact surface 13a of the electromagnet 13 and the contact surface 12a of the casing 12. The milking stall 2 is now ready to receive a new cow 1.

FIG. 4 shows an alternative milking stall for automatic milking of cows 1. The milking stall comprises a fence arrangement defining the milking stall. The fence arrangement comprises a front short side section 2a, a rear short side section 2b, a right long side section 2c and a left long side section, which in this case constitutes a gate 2d₃ to the milking stall 2. The milking stall 2 comprises a schematically disclosed milking robot 3 configured to attach teat cups to the teats of a cow 1 in the milking stall. A first extensible power member in the form of a first pneumatic cylinder 7a is arranged between the right long side section 2c and the gate 2d₃ at a front portion of the milking stall 2. A second extensible power member in the form of a second pneumatic cylinder 7b is arranged between the right long side section 2c and the gate 2d₃ at a rear portion of the milking stall 2. The first pneumatic cylinder 7a and the second pneumatic cylinder 7b are connected to upper parts of the right long side section 2c and the gate 2d₃. The first pneumatic cylinder 7a and the second pneumatic cylinder 7b are arranged at a level above the cow 1 in the milking stall. A control unit 5 controls the activation of the pneumatic cylinders 7a, 7b. The identity of the cow 1 in the milking stall is sensed by an identification sensor 6. The identification sensor 6 is arranged in a suitable place in or outside the milking stall 2.

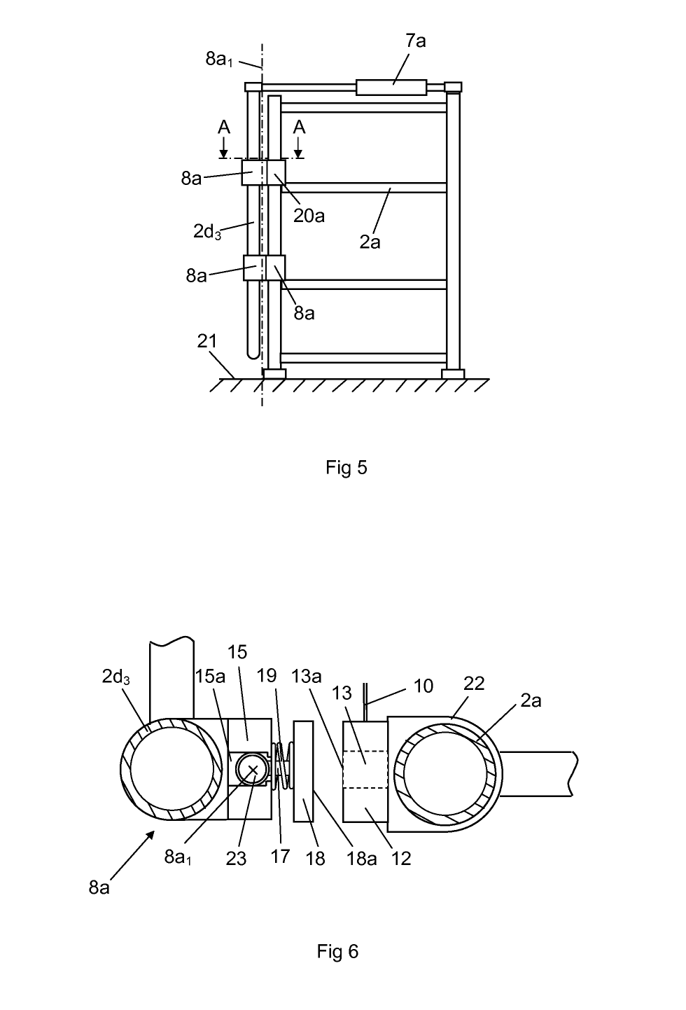

FIG. 5 shows a front view of the milking stall 2. A front end of the gate 2d₃ is connected to the front short side section 2a by means of a first pair of electromagnetic lock and hinge mechanisms 8a. The first pair of electromagnetic lock and hinge mechanisms 8a are arranged at different heights above a floor 21 in the milking stall. The first pair of electromagnetic lock and hinge mechanisms 8a allows a swinging movement of gate 2d₃ around a first vertical axis 8a₁. A rear portion of the gate 2d₃ is pivotally connected to the second fence section 2b by means of a second pair of electromagnetic lock and hinge mechanisms 8b. The second pair of electromagnetic lock and hinge mechanisms 8b is also arranged at different heights above the floor 21. The second pair of electromagnetic lock and hinge mechanisms 8b allows a swinging movement of the gate 2d₃ around a second vertical axis 8b₁.

FIG. 6 shows one of the first pair of electromagnetic lock and hinge mechanisms 8a in more detail. The electromagnetic lock and hinge mechanism 8a comprises a support member 22 fixedly attached to a vertical end post of the front short section 2a. The support member 22 supports a casing 12 containing an electromagnet 13. An electric wiring 10 is connected to a non visible coil wrapped around the electromagnet 13 inside the casing 12. The control unit 5 comprises software 5a which feeds a desired amount of current to the coil. The electromagnetic lock and hinge mechanism 8a can be set in an unlocked state and in at least two different locked states. In the unlocked state, the control unit 5 feeds no current to the electromagnetic lock and hinge mechanism 8a. In the locked states, the control unit 5 feeds different amounts of current to the first pair of electromagnetic lock and hinge mechanisms 8a in the respective locked states.

The electromagnetic lock and hinge mechanism 8a comprises an attaching member 15 fixedly attached to a vertical post of the gate 2d₃. The attaching member 15 comprises a through hole 15a. A vertical pivot 23 is displaceably arranged in the through hole 15a.

The pivot 23 is connected to a plate-shaped contact member 18 by means of a pin 17. The pivot 23, the pin 17 and the contact member 18 constitute a connected unit. The pivots 23 of the first pair of electromagnetic lock and hinge mechanisms 8a provide the swinging movement of the gate 2d₃ around the first vertical axis 8a₁. A spring member 19 is arranged between a wall surface of the attaching member 15 and a wall surface of the connecting member 18. The spring member 19 provides a resilient suspension of the contact member 18, the pin 17 and the pivot 23 in relation to the attaching member 15. The contact member 18 comprises a contact surface 18, configured to come in contact with a contact surface 13a of the electromagnet 13 when the gate 2d₃ is in a closed position. The second pair of electromagnetic lock and hinge mechanisms 8b, which are arranged at the rear portion of the milking stall 2, has a corresponding construction as the first pair of electromagnetic lock and hinge mechanisms 8a at the front portion of the milking stall. The control unit 5 is capable of setting the second pair of electromagnetic lock and hinge mechanisms 8b in an unlocked state and in at least one locked state. The pivots of the second pair of electromagnetic lock and hinge mechanisms 8b provide the swinging movement of the gate 2d₃ around the second vertical axis 8b₁.

When the gate 2d₃ is in a closed position, the first pair 8a and the second pair 8b of electromagnetic lock and hinge mechanisms are in a locked state. As soon as a cow 1 is to be milked in the milking stall, the control unit 5 feeds no current to the second pair of electromagnetic lock and hinge mechanisms 8b. Thus, the second pair of electromagnetic lock and hinge mechanisms 8b is set in the unlocked state and the force between the electromagnets 13 and the contact members 18 ceases. Thereafter, the control unit 5 activates the second pneumatic cylinder 7b such that it moves the rear end of the gate 2d₃ outwardly from the milking stall. The length of the first pneumatic cylinder 7a is substantially unchanged and the gate 2d₃ performs an outward swinging movement around the first pivot axis 8a₁ to a first open position which is indicated with dotted lines in FIG. 4.

When the gate 2d₃ is in the first open position, an entrance opening to the milking stall is exposed at the rear portion of the milking stall 2, and the cow 1 enters the milking stall 2 via the entrance opening. When the whole cow 1 is in the milking stall, the control unit 5 activates the second pneumatic cylinder 7b such that it is retracted, and the rear end of the gate 2d₃ is moved back to the closed position. When the gate 2d₃ reaches the closed position, the contact surfaces 18a of the contact members 18 have been automatically adjusted to an optimized contact with the contact surfaces 13a of the electromagnets 13 by means of the suspension of the contact members 18 in the second pair of electromagnetic lock and hinge mechanisms 8. The control unit 5 feeds current to the electromagnets 13 in the second pair of electromagnetic lock and hinge mechanisms 8b. The electromagnets 13 of the second pair of electromagnetic lock and hinge mechanisms 8b are now connected to the contact members of the rear part of the gate 2d₃. The second pair of electromagnetic lock and hinge mechanisms 8b is now in a locked state and holds the gate 2d₃ with a locking force at the rear portion of the milking stall.

The identification sensor 6 detects the identity of the cow 1. The control unit 5 determines by means of, for example, stored data about individual cows 1 a suitable locking force of the gate 2d₃ for this individual cow 1. The control unit 5 feeds an amount of current to the electromagnets 13 of at least one of said pairs of electromagnetic lock and hinge mechanisms 8a, 8b such that the gate 2d₃ at least at one end of the milking stall 2 is locked by the elected specific locking force. The elected specific locking force is of a value such that it is difficult for the cow 1 to open the gate 2d₃ in the closed state, but possible if the cow 1 is panic-stricken. The control unit 5 activates the milking robot 3 such that it attaches teat cups to the teats of the cow 1 and the milking process starts.

When the milking process has finished and it is time for the cow 1 to leave the milking stall, the control unit 5 feeds no current to the electromagnets of the first pair of electromagnetic lock and hinge mechanisms 8a. The electromagnetic force acting between the contact members 18 and the electromagnets 13 in the first pair of electromagnetic lock and hinge mechanisms 8a ceases. The control unit 5 activates the first pneumatic cylinder 7b such that it extends and moves the front end of the gate 2d₃ outwardly from the milking stall. The length of the second pneumatic cylinder 7b is substantially unchanged during this motion, and the gate 2d₃ performs an outward swinging movement around the second pivot axis 8b to a second open position which is indicated with dashed lines in FIG. 4. When the gate 2d₃ is in the second open position, an exit opening to the milking stall 2 is exposed at the front portion of the milking stall 2, and the cow 1 leaves the milking stall 2.

The invention is not limited to the described embodiments but may be varied and modified freely within the scope of the claims.

1-21. (canceled)

22. A gate arrangement in a fenced area (2) for a livestock animal, the gate arrangement comprising:
a fenced area (2) that houses the livestock animal;
a gate (2d2, 2d3) located in an opening of the fenced area (2), the gate (2d2, 2d3) movable between a closed position and an open position;
an electromagnetic lock mechanism (8, 8a, 8b) that provides the gate (2d2, 2d3) with an unlocked state and a locked state,
wherein in the locked state the lock mechanism (8, 8a, 8b) locks the gate (2d2, 2d3) in the closed position with a specific locking force selected from plural locking forces,
wherein the electromagnetic lock mechanism (8, 8a, 8b) comprises a force adjusting unit (5) that selectively adjusts the electromagnetic lock mechanism (8, 8a, 8b) to provide the selected specific locking force; and
a control unit (5) operatively connected to the lock mechanism,
wherein the control unit (5) i) receives information about the animal (1) in the fenced area (2) based on an identity sensor (6) on the animal (1), ii) selects the specific locking force based on the received information about the animal (1) in the fenced area (2), and iii) controls the force adjusting unit (5) such that the lock mechanism (8, 8a, 8b) locks the gate (2d2, 2d3) with the selected specific locking force.

23. The gate arrangement according to claim 22, wherein,
the received information about the animal (1) in the fenced area (2) is a weight of the animal, and
the control unit (5) locks the gate (2d2, 2d3) with the specific locking force based on the received weight of the animal (1) in the fenced area (2).

24. The gate arrangement according to claim 22,
wherein the lock mechanism (8, 8a, 8b) further comprises i) a first part comprising an electromagnet (13) with a first contact surface (13a), and ii) a second part comprising a contact member (18) with a second contact surface (18a) that, in a contact position, contacts the first contact surface (13a) of the electromagnet (13), the second contact surface (18a) being of a magnetizable material,
wherein the force adjusting unit (5) selectively adjusts the locking force between at least a first locking force and a second locking force, the second force being greater than the first force,
wherein the positioning adjusting unit adjusts relative positions of the first contact surface (13a) of the electromagnet (13) with respect to the second contact surface (18a) of the contact member (18), the adjusted relative positions including a first relative position that provides the first locking force in the contact position and a second relative position that provides the second locking force in the contact position,
wherein with the lock mechanism in the locked state locking the gate in the closed position and with the first relative position that provides the first locking force, a third force applied to the gate (2d2, 2d3) opens the gate (2d2, 2d3) without deformation of any components of the lock mechanism when the third force is greater than the first locking force, and
wherein with the lock mechanism in the locked state locking the gate in the closed position and with the second relative position that provides the second locking force, a fourth force applied to the gate (2d2, 2d3) opens the gate (2d2, 2d3) without deformation of any components of the lock mechanism when the fourth force is greater than the second locking force.

25. The gate arrangement according to claim 23,
wherein the lock mechanism (8, 8a, 8b) further comprises i) a first part comprising an electromagnet (13) with a first contact surface (13a), and ii) a second part comprising a contact member (18) with a second contact surface (18a) that, in a contact position, contacts the first contact surface (13a) of the electromagnet (13), the second contact surface (18a) being of a magnetizable material,
wherein the force adjusting unit (5) selectively adjusts the locking force between at least a first locking force and a second locking force, the second force being greater than the first force,
wherein the positioning adjusting unit adjusts relative positions of the first contact surface (13a) of the electromagnet (13) with respect to the second contact surface (18a) of the contact member (18), the adjusted relative positions including a first relative position that provides the first locking force in the contact position and a second relative position that provides the second locking force in the contact position,
wherein with the lock mechanism in the locked state locking the gate in the closed position and with the first relative position that provides the first locking force, a third force applied to the gate (2d2, 2d3) opens the gate (2d2, 2d3) without deformation of any components of the lock mechanism when the third force is greater than the first locking force, and
wherein with the lock mechanism in the locked state locking the gate in the closed position and with the second relative position that provides the second locking force, a fourth force applied to the gate (2d2, 2d3) opens the gate (2d2, 2d3) without deformation of any components of the lock mechanism when the fourth force is greater than the second locking force.

26. The gate arrangement according to claim 24, further comprising a stationary element (2a, 2b, 2d) in a vicinity of the opening of the fenced area, wherein,
one of said first and second parts of the lock mechanism (8) is mounted on the stationary element (2a, 2b, 2d), and
another of said first and second parts of the lock mechanism (8) is mounted on the gate (2d2, 2d3).

27. The gate arrangement according to claim 26, wherein the first part of the lock mechanism comprises a casing (12) arranged around the electromagnet (13).

28. The gate arrangement according to claim 27, wherein the casing (12) has an opening defined by the first contact surface (12a) and in a same plane as the second contact surface (13a) of the electromagnet (13) when the first and second contact surfaces (12a, 13a) are in contact in the contact position.

29. The gate arrangement according to claim 24, wherein said positioning adjusting unit further comprises a resilient suspension (15a, 16, 23, 17, 19) associated with the contact member (18).

30. The gate arrangement according to claim 29, wherein said positioning adjusting unit further comprises an angle adjusting part (16, 23, 17, 19) that adjusts a relative angle between the first contact surface (13a) of the electromagnet (13) and the second contact surface (18a) of the contact member (18).

31. The gate arrangement according to claim 30, wherein said angle adjusting unit comprises a joint element (16) that provides a universal angle adjustment of the contact member (18) relative to the electromagnet (13).

32. The gate arrangement according to claim 30, wherein said angle adjusting unit comprises a joint element (23) that provides a rotary motion of the contact member (18) around a pivot axis (8a1, 8b1).

33. The gate arrangement according to claim 24, further comprising:
a power member (7a, 7b) that moves the gate (2d2, 2d3) between the open position and the closed position,
wherein the control unit (5) controls the power member (7a, 7b) to move the gate (2d2, 2d3) between the open position and the closed position.

34. The gate arrangement according to claim 24, wherein the control unit (5), based on the received information about the animal (1), selects the specific locking force to be one of the first and second locking forces, and controls the force adjusting unit (5) such that the lock mechanism (8, 8a, 8b) locks the gate (2d2, 2d3) with the selected one of the first and second locking forces.

35. The gate arrangement according to claim 34, wherein the selected one of the first and second locking forces depends on a weight of the identified animal (1) in the fenced area (2).

36. The gate arrangement according to claim 22, wherein the lock mechanism (8, 8a, 8b) is arranged at a level that is closer to a level of a highest part of the gate (2d2, 2d3) than a level of a lowest part of the gate (2d2, 2d3).

37. The gate arrangement according to claim 22, wherein the fenced area is a milking stall (2) and the animal is a cow.

38. The gate arrangement according to claim 37, wherein the milking stall is an automatic milking stall (2) provided with a milking robot (3).

39. The gate arrangement according to claim 38, wherein,
the gate is an exit gate (2d2, 2d3) of the milking stall (2), and
the lock mechanism further comprises a hinge mechanism (8a, 8b) connected to the gate (2d3).

40. The gate arrangement according to claim 39, comprising a further one of said electromagnetic lock mechanism (8, 8a, 8b) and a further one of said hinge mechanism (8a, 8b), wherein,
the electromagnetic lock mechanism (8, 8a, 8b) and the hinge mechanism (8a) is located at a first end portion of the gate (2d3) such that the gate pivots about a first axis (8a1) associated with the first end portion of the gate (2d3), and
the further electromagnetic lock mechanism (8, 8a, 8b) and the further hinge mechanism (8a) is located at a second end portion of the gate (2d3) such that the gate pivots about a second axis (8b1) associated with the second end portion of the gate (2d3), the second end portion of the gate being at an end opposite to the first end portion of the gate.

41. A livestock gate arrangement, comprising:
a fenced area (2) to house a livestock animal with an identity sensor (6);
a gate (2d2, 2d3) located in an opening of the fenced area (2), the gate (2d2, 2d3) movable between a closed position and an open position in the opening of the fenced area (2); and
an electromagnetic lock mechanism (8, 8a, 8b) that provides the gate (2d2, 2d3) with an unlocked state and a locked state; and
a control unit (5) operatively connected to the lock mechanism, wherein the control unit (5) receives information about the animal (1) in the fenced area (2) based on the identity sensor (6) on the animal (1),
wherein the lock mechanism (8, 8a, 8b) comprises
i) a first part comprising an electromagnet (13) with a first contact surface (13a),
ii) a second part comprising a contact member (18) with a second contact surface (18a) that, in a contact position, contacts the first contact surface (13a) of the electromagnet (13), the second contact surface (18a) being of a magnetizable material, and
iii) a force adjusting unit (5) that selectively adjusts the locking force between at least a first locking force and a second locking force, the second force being greater than the first force, the force adjusting unit comprising a positioning adjusting unit that adjusts a relative position of the first contact surface (13a) of the electromagnet (13) with respect to the second contact surface (18a) of the contact member (18), the adjusted relative position including a first relative position that provides the first locking force and a second relative position that provides the second locking force,
wherein with the lock mechanism in the locked state locking the gate in the closed position and with the first relative position that provides the first locking force, a third force applied to the gate (2d2, 2d3) opens the gate (2d2, 2d3) without deformation of any components of the lock mechanism when the third force is greater than the first locking force,
wherein with the lock mechanism in the locked state locking the gate in the closed position and with the second relative position that provides the second locking force, a fourth force applied to the gate (2d2, 2d3) opens the gate (2d2, 2d3) without deformation of any components of the lock mechanism when the fourth force is greater than the second locking force, and
wherein the control unit (5) i) selects a specific locking force, the specific locking force being one of the first and second locking forces, and ii) controls the force adjusting unit (5) such that the lock mechanism (8, 8a, 8b) locks the gate (2d2, 2d3) with the selected specific locking force.
